(19) United States
(12) Patent Application Publication
(10) Pub. No.: US 2014/0129634 A1
(43) Pub. Date: May 8, 2014

(54) SOCIAL MEDIA-BASED CONTENT RECOMMENDATION APPARATUS

(71) Applicant: Electronics and Telecommunications Research Institute, Daejeon (KR)

(72) Inventors: Myung-Eun KIM, Daejeon (KR); Hyung-Woo KIM, Seongnam (KR)

(21) Appl. No.: 13/940,222

(22) Filed: Jul. 11, 2013

(30) Foreign Application Priority Data
Nov. 8, 2012 (KR) 10-2012-0126195

(51) Int. Cl. H04L 29/06

(52) U.S. Cl. CPC H04L 65/403
USPC 709/204

(57) ABSTRACT

There is provided a social media-based content recommendation apparatus including: an information collection unit configured to search one or more social media sites on the basis of received social media profile information to collect social medial information about content and deliver the social media information, an information analysis unit configured to extract one or more representative words according to an appearance frequency on the basis of the delivered social media information, determine whether a meaning of each of the extracted representative words is positive or negative, and generate and deliver content analysis information including the determination result; and a content recommendation unit configured to select recommendable content on the basis of the delivered content analysis information and deliver information about the selected recommendable content.

### CROSS-REFERENCE TO RELATED APPLICATION

This application claims the benefit under 35 U.S.C. §119(a) of Korean Patent Application No. 10-2012-0126195, filed on Nov. 8, 2012, the entire disclosure of which is incorporated herein by reference for all purposes.

### BACKGROUND

1. Field

The following description relates to an apparatus and method for recommending multimedia content, and more particularly, to a social media-based multimedia content recommendation apparatus and method capable of facilitating consumption of multimedia contents.

2. Description of the Related Art

Recently, with the convergence of broadcasting with communication infrastructure, users can use a variety of multimedia terminals to consume desired content at a desired time. A typical content consumption method is to watch content broadcast by a terrestrial broadcasting station through an existing TV terminal. However, as Internet technology progresses, the content may be consumed through a variety of multimedia terminals and also consumption patterns may change significantly. Nowadays, users desire to retrieve and view their favorite programs via the Internet in addition to terrestrial broadcasting. Thus, interest in intelligent content recommendation technology for automatically recommending popular contents suited to the user's preferences before the user retrieves the content is increasing.

In the related art, content has been recommended corresponding to specific information about a genre, an actor, a director, etc. preferred by a user on the basis of profile information filled in by the user. However, this method has a limitation in that since the user profile is not continuously updated, it is difficult to reflect the user's dynamically changing tendencies.

Recently, social media have entered the spotlight as new communication tools, and large numbers of people voice their opinions on broadcasting and a variety of multimedia contents through social media. Content consumers tend to purchase specific contents with reference to the variety of opinions on the contents in social media. Social media is defined as an open online platform through which individuals and communities share, co-create, discuss, and modify user-generated content such as ideas, opinions, experiences, information, etc., on the basis of a social network. Social media include blogs, social network services (SNSs), user created contents (UCCs), WIKIs, micro-blogs, etc.

Accordingly, there is a need to develop social media-based recommendation technology for collecting information about multimedia contents from a variety of social media, analyzing the information, and then selecting and recommending popular contents. In the related art, a user's preferred contents are recommended on the basis of a static user profile that is not dynamically updated. Thus, the recommendation does not reflect the user's recent preferences.

Korean Patent Application No. 2009-0080857 discloses a social network-based content recommendation system. This application discloses a method of recommending content on the basis of scores given by users on a social network and ranks of the users. However, this method recommends content only using user ranks and scores, instead of effectively analyzing a variety of information on the social network.

### SUMMARY

The following description relates to a content recommendation apparatus and method for analyzing social media in real time to recommend to a user content that has gained popularity in social media, thereby compensating for the limitations of user profile-based search and recommendation technology.

In one general aspect, a social media-based content recommendation apparatus includes: an information collection unit configured to search one or more social media sites on the basis of received social media profile information to collect social medial information about content and deliver the social media information, an information analysis unit configured to extract one or more representative words according to an appearance frequency on the basis of the delivered social media information, determine whether a meaning of each of the extracted representative words is positive or negative, and generate and deliver content analysis information including the determination result; and a content recommendation unit configured to select recommendable content on the basis of the delivered content analysis information and deliver information about the selected recommendable content. The social media-based content recommendation apparatus according to the present invention further includes: a profile management unit configured to receive social media profile information from a user terminal; and a data storage unit configured to store and manage the social media profile information, the social media information, the content analysis information, and the information about selected recommendable content.

The information analysis unit may extract a representative word which appears frequently, using a term frequency (TF) technique and an inverse document frequency (IDF) technique. Also, the information analysis unit may determine whether the meaning of the extracted representative word is positive or negative using a sentimental analysis technique.

In another general aspect, a social media-based content recommendation method includes: receiving social media profile information, searching one or more social media sites for information about content on the basis of the received social media profile information, analyzing retrieved information about the content, and generating content recommendation information on the basis of the analyzed information about the content.

Other features and aspects will be apparent from the following detailed description, the drawings, and the claims.

### BRIEF DESCRIPTION OF THE DRAWINGS

FIG. 1 is a block diagram showing a social media-based content recommendation apparatus 100 according to an embodiment of the present invention.

FIG. 2 is a block diagram showing an example of a user interface of the social media-based content recommendation apparatus according to an embodiment of the present invention.

FIG. 3A illustrates a first region 310 of another example of the user interface of the social media-based content recommendation apparatus according to an embodiment of the present invention.

FIG. 3B illustrates a second region 320 of the other example of the user interface of the social media-based content recommendation apparatus according to an embodiment of the present invention.

FIG. 4 is a flowchart illustrating a social media-based content recommendation method according to an embodiment of the present invention.

Throughout the drawings and the detailed description, unless otherwise described, the same drawing reference numerals will be understood to refer to the same respective elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

Hereinafter, embodiments of the present invention will be described in detail with reference to the accompanying drawings. Terms used herein are terms that have been selected in consideration of functions and effects in embodiments, and the meanings of the terms may be altered according to the intent of a user or operator, or conventional practice. Therefore, the meanings of terms used in the below-described embodiments confirm to definitions when defined specifically in the specification, but when there is no detailed definition, the terms should be construed as meanings known to those skilled in the art.

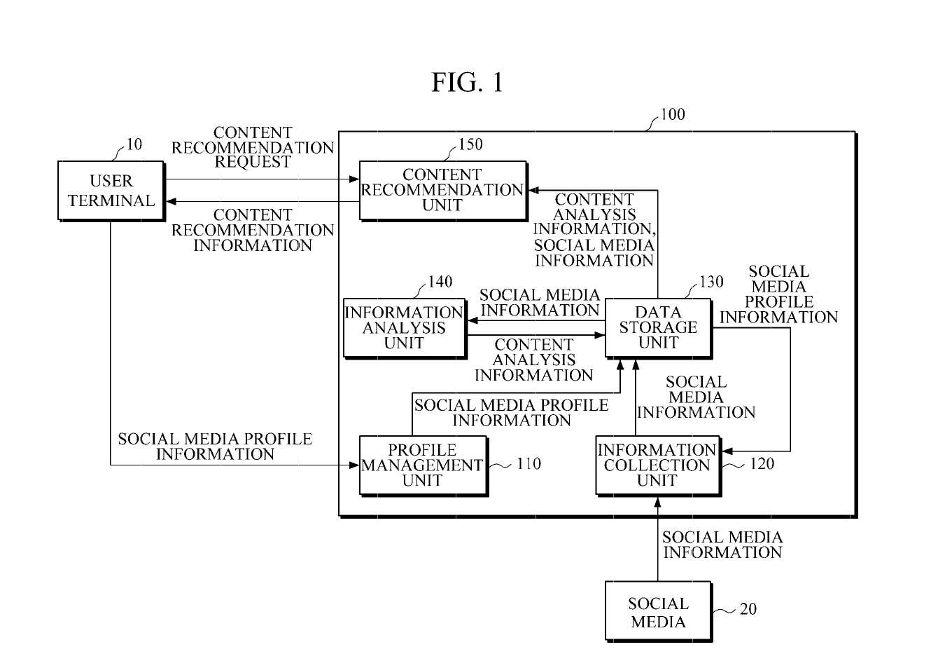

FIG. 1 is a block diagram showing a social media-based content recommendation apparatus 100 according to an embodiment of the present invention.

Referring to FIG. 1, the social media-based content recommendation apparatus 100 according to an embodiment of the present invention includes a profile management unit 110, an information collection unit 120, a data storage unit 130, an information analysis unit 140, and a content recommendation unit 150.

The profile management unit 110 receives social media profile information from a user terminal 10. The social media profile information includes personal information about a user and information about a social media site. The personal information about a user may include personal identity information about a user, a personal taste, a use frequency of content, a use time of content, and a type of content. The information about social media may include a type of social media used by a user, a use frequency of social media, user identification/password for social media, and information about another user registered with social media.

Also, the social media profile information may include information about a predetermined search target among one or more social media sites and may include information about a predetermined user search range for each social media site. The user search range for each social media site may be set to a number of unspecified persons or to only registered users, such as persons in a friend list. The social media profile information may include information about a desired search period set by a user. Through the setting of the search period, information about content receiving attention during a specific period or at a specific date may be checked.

The profile management unit 120 delivers the received social media profile information to the data storage unit 130 and manages the social media profile information stored in the data storage unit 130.

The information collection unit 120 searches a social media site 20 on the basis of the social media profile information received from the data storage unit 130 and collects social media information according to the search result.

First, the information collection unit 120 sets a search range of the social media site 20 on the basis of the received social media profile information. The search range of the social media site 20 may be set to all social media used by a user included in the social media profile information, or may be flexibly set according to the use frequency used by a user. Alternatively, the search range may be set to all of predetermined social media, irrespectively of use by users. The search range of the social media site 20 may be set on the basis of the received social media profile information. However, the search range is not limited to a specific range and may differ depending on a purpose, intention, and setting of a user.

And, the information collection unit 120 sets an information collection range of the social media on the basis of the received social media profile information. The information collection range of the social media denotes a range of users for collecting information for contents recommendation, among users of each social media site. For example, the information collection range is set to another user or friend registered with a user, and the information may be collected from only registered friends. Alternatively, the information may be collected from a number of unspecified persons using the corresponding social media. The information collection range may be set on the basis of the received social media profile information. However, the information collection range is not limited to a specific range and may differ depending on a purpose, intention, and setting of a user.

The information collection unit 120 collects social media information about content from social media according to the social-media search range and information collection range. The social media information may include information about recommendations and evaluations of content included in the social media and writings or opinions written in the social media.

In this case, the information collection unit 120 establishes and stores metadata about content to be collected, in advance. Then, the information collection unit 120 delivers the collected social media information to the data storage unit 130.

The data storage unit 130 stores the social media profile information received from the profile management unit 110, social media information received from the information collection unit 120, and the content analysis information received from the information analysis unit 140. Also, the data storage unit 130 delivers the stored social media profile information to the information collection unit 120, delivers the stored social media information to the information analysis unit 140, and delivers the stored content analysis information to the content recommendation unit 150.

The information analysis unit 140 generates content analysis information on the basis of the social media information received from the data storage unit 130. The information analysis unit 140 extracts a representative word, which appears frequently, from the social media information collected for each content item using a term frequency (TF) technique and an inverse document frequency (IDF) technique. TF is a value indicating how often a specific word appears in a document, and IDF indicates the inverse of a value indicating the number of documents in which a specific word appears. That is, a word appearing frequently in multiple writings or documents included in the social media information collected from the social media site 20 is considered and extracted as a representative word. The criterion for being the representative word may be determined using a predetermine threshold value.

The information analysis unit 140 determines whether the meaning of the extracted representative word is positive or negative using a sentimental analysis technique. The sentimental analysis technique is an analysis technique for text to determine whether a sentence is positive or negative, or to learn intentions or information about likes and dislikes. For example, by analyzing a sentence in which specific content is mentioned using the sentimental analysis technique, it may be checked whether the sentence is positive or negative with respect to the specific content. That is, a tendency for recommendation or disapproval of specific content may be deduced from sentences written on the social media site 20. Next, the information analysis unit 140 generates content analysis information including information classified using a sentimental analysis technique and delivers the generated content analysis information to the data storage unit 130.

The content recommendation unit 150 generates content recommendation information on the basis of the content analysis information received from the data storage unit 130 and delivers the generated content recommendation information to the user terminal 10. The content analysis information includes classification information about whether each sentence included in the social media site 20 is positive or negative with respect to each content item. Accordingly, the content recommendation unit 150 includes content recommendation information including information about the recommendable content on the basis of the content analysis information. The content recommendation information may identify a type of the content, rank the content, and then provide the content, or may first recommend content recommended by a close friend. On the other hand, the content recommendation information may include information about disapproved content.

The content recommendation unit 150 may search for content receiving attention on the basis of the received content analysis information, find social information about the searched content, and configure the content recommendation information in a tag cloud form. Also, the content recommendation unit 150 may search for content recommendation information according to a period input by a user. For example, the determination may be performed only using information written on the social media today or yesterday, among content recommendation information collected from the social media and then analyzed, or only using information during a certain period such as one week or one month. The tag cloud analyzes tags obtained from metadata and displays the tags in consideration of their importance or popularity.

In the configuration of the tag cloud, a positive word may be displayed in a light color, a negative word may be displayed in a dark color, a word having high TF and IDF values due to frequent appearance in the social media site 20 is represented in a large font, and a word having low TF and IDF values may be displayed in a small font, thereby allowing a user to directly understand why the content has received attention from the social media. If the user terminal 10 supports a 3D function, a word that frequently appears may be displayed to protrude forward, and a word that does not frequently appear may not. A method of displaying the content recommendation information is not limited to the above description. However, a variety of display methods or interfaces for determining whether or to what degree a user recommends the content may be used.

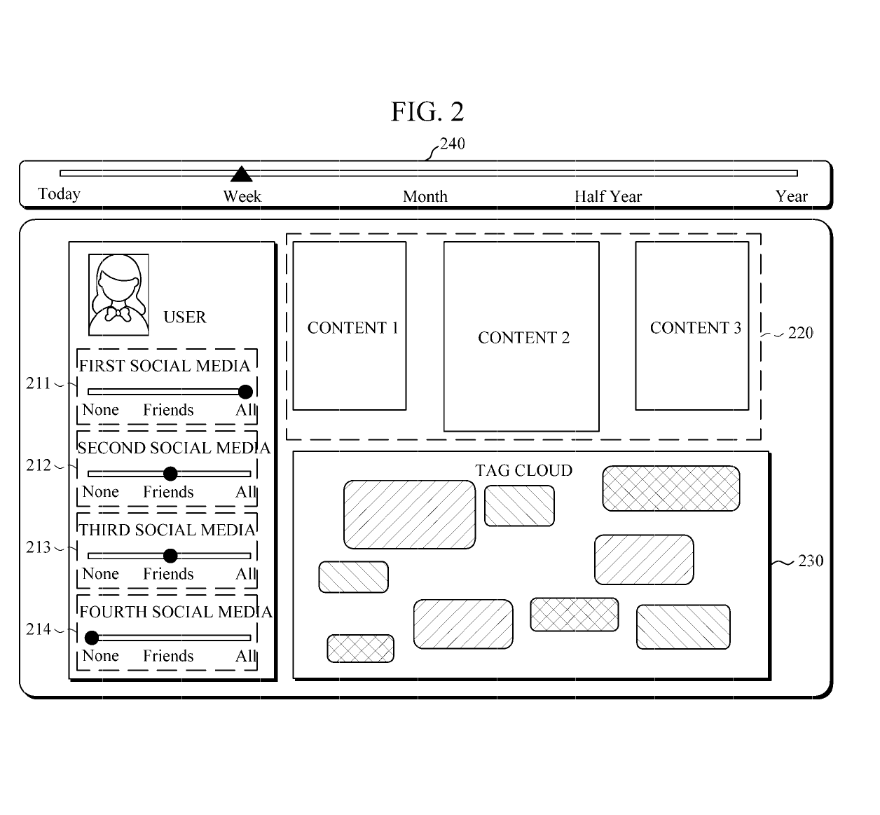

FIG. 2 is a block diagram showing an example of a user interface of the social media-based content recommendation apparatus according to an embodiment of the present invention.

Referring to FIG. 2, a user interface of the social media-based content recommendation apparatus according to an embodiment of the present invention includes a social profile setting information display portion 210, recommendable content display portion 220, a tag cloud display portion 230, and a period setting portion 240.

The social profile setting information display portion 210 may display a social media site used by a user and set an information collection range of the displayed social media site. For example, a first social media site 211 may have a search range set to all unspecified persons, each of a second social media site 212 and a third social media site 213 may have a search range to only users registered as friends, a fourth social media site 214 may be excluded from the search.

The recommendable content display portion 220 displays content recommended according to a result analyzed by a social media-based content recommendation apparatus. The recommendable content has a grade given according to a recommendation degree that may be identified on the basis of size and color. For example, content recommended or positively evaluated by more persons may be displayed in a larger size than other contents. A user may select desired content on the recommendable content display portion 220.

The tag cloud display portion 230 displays social information about the content selected by a user from among contents included in the recommendable content display portion 220, in a tag cloud form. For example, if a user selects a second content item from among two or more content items displayed on the recommendable content display portion 220, the tag cloud display portion 230 displays a tag cloud for the second content item. The social information about the content selected by the user includes text of the social media for the recommendable content display portion 220.

The tag cloud display portion 230 may display a positive word in a light color and a negative word in a dark color, among a plurality of pieces of information about the content selected by the user on the basis of the content recommendation information. Also, a word having high TF and IDF values due to frequent appearance in the social media may be displayed in a large font, and a word having low TF and IDF values may be displayed in a small font. Thus, a user can directly understand whether the content has received attention from the social media and why the content has been recommended.

The period setting portion 240 may allow a user to set a search period of social media. For example, the user may search for only content that has received attention from social media during just one day, today, or during a predetermined period such as one week, one month, or one year.

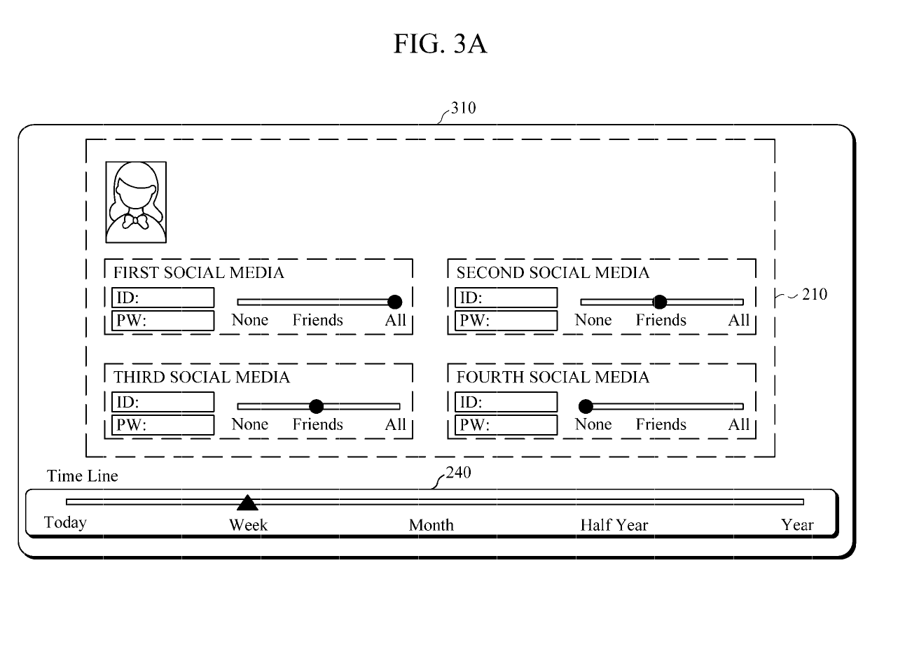

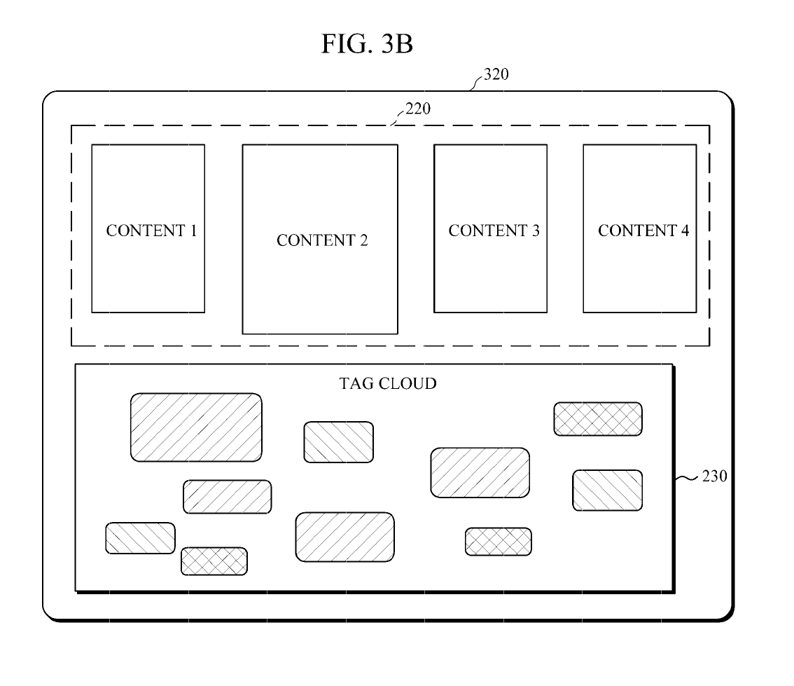

FIG. 3A illustrates a first region 310 of another example of the user interface of the social media-based content recommendation apparatus according to an embodiment of the present invention, and FIG. 3B illustrates a second region 320 of the other example of the user interface of the social media-based content recommendation apparatus according to an embodiment of the present invention.

Referring to FIGS. 3A and 3B, the other example of the user interface of the social media-based content recommendation apparatus according to an embodiment of the present invention is an interface for displaying the social profile setting information display portion 210 and the period setting portion 240 separate from the recommendable content display portion 220 and the tag cloud display portion 230. If a user sets a search range through the social profile setting information display portion 210 and the period setting portion 240 displayed on the first screen 310, the first screen 310 is switched to the second screen 320 and thus the user may check the recommendable content display portion 220 and the tag cloud display portion 230 displayed on the second screen 320. The first and second screens 310 and 320 are not simultaneously displayed; only one of the first and second screens 310 and 320 is displayed and they can be switched whenever a user makes a request. Thus, the user can check a necessary interface on a larger screen, where more recommendable content display portions 220 and more tag cloud display portions 230 may be displayed.

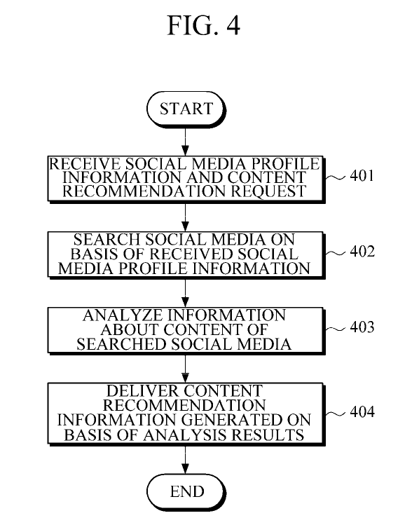

FIG. 4 is a flowchart illustrating a social media-based content recommendation method according to an embodiment of the present invention.

Referring to FIG. 4, the social media-based content recommendation method according to an embodiment of the present invention involves first receiving social media profile information and a content recommendation request (401). The social media profile information may include a type of social media used by a user, a use frequency of social media, user identification/password for social media, and information about another user registered with social media.

Also, the social media profile information may include information about a predetermined search target among two or more social media sites and may include information about a predetermined user search range for each social media site. The user search range for each social media site may be set to a number of unspecified persons or to only registered users, such as persons in a friend list. The social media profile information may include information about a desired search period set by a user. Through the setting of the search period, information about content receiving attention during a specific period or at a specific date may be checked.

The method involves searching social media on the basis of the received social media profile information (402). The received social media profile information includes information about the social media to be searched and information about a search range and a search period of the social media. On the basis of such information, information about content for a user within the search range set for the social media is searched and collected.

For example, the search range of the social media may be set to all social media used by a user included in the social media profile information, or may be flexibly set according to the frequency of use by users. Alternatively, the search range may be set to all of predetermined social media, irrespectively of use by users.

For example, the information collection range of the social media may be set to all or some of other users such as a friend registered with a user on the basis of the received social media profile information. Alternatively, the information may be collected from a number of unspecified persons using the corresponding social media.

The search range and information collection range of the social media may be set on the basis of the received social media profile information. However, the ranges are not limited to a specific range and may differ depending on a purpose, intention, and setting of a user.

The method involves analyzing information about the content of the social media on the basis of the search results (403). A representative word, which appears frequently, is extracted from the social media information collected for each content item using a term frequency (TF) technique and an inverse document frequency (IDF) technique. TF is a value indicating how often a specific term appears in a document, and IDF indicates the inverse of a value indicating the number of documents in which a specific term appears.

Also, the method involves determining whether the meaning of the extracted representative word is positive or negative using a sentimental analysis technique. The sentimental analysis technique is an analysis technique for analyzing text to determine whether a sentence is positive or negative or to learn intentions or information about likes and dislikes. That is, the method is used to analyze the sentence written on the social media to find out a tendency for recommendation or disapproval of specific content.

Next, the method involves delivering content recommendation information on the basis of the analyzed information about the content (404). The analyzed information about the content identifies information about the content among multiple pieces of information collected from the social media, and includes information about recommendable content in consideration of a positive or negative expression with regard to the content and an appearance frequency of the content among the information of the content. Accordingly, the method delivers the content recommendation information including the information about the recommendable content to a user terminal.

The content recommendation information may identify a type of the content, rank the content, and then provide the content, or may first recommend content recommended by a close friend. Also, the content recommendation information may include information about disapproved content. The content recommendation information may find social information about each content item, and configure the content recommendation information in a tag cloud form. In the configuration of the tag cloud, a positive word may be displayed in a light color, a negative word may be displayed in a dark color, a word having high TF and IDF values due to frequent appearance in the social media may be displayed in a large font, and a word having low TF and IDF values may be displayed in a small font, thereby allowing a user to directly understand why the content has received attention from the social media.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A social media-based content recommendation apparatus comprising:
an information collection unit configured to search one or more social media sites to collect social medial information about content;
an information analysis unit configured to extract one or more representative words according to an appearance frequency on the basis of the collected social media information, determine whether a meaning of each of the extracted representative words is positive or negative, and generate content analysis information including the determination result; and
a content recommendation unit configured to select recommendable content on the basis of the generated content analysis information and generate information about the selected recommendable content.

2. The social media-based content recommendation apparatus of claim 1, further comprising:
a profile management unit configured to receive social media profile information from a user terminal; and
a data storage unit configured to store and manage the social media profile information, the social media information, the content analysis information, and the information about selected recommendable content.

3. The social media-based content recommendation apparatus of claim 1, wherein the information collection unit searches one or more social media sites on the basis of social media profile information received from a user.

4. The social media-based content recommendation apparatus of claim 3, wherein the social media profile information comprises search period information about the social media and user search range information about the social media.

5. The social media-based content recommendation apparatus of claim 1, wherein the information collection unit selects one or more of the one or more social media sites on the basis of the social media profile information, selects a user search range of the selected social media, and selects a search period of the selected social media.

6. The social media-based content recommendation apparatus of claim 1, wherein the information analysis unit extracts a representative word that appears more than a predetermined number of times, using a term frequency (TF) technique and an inverse document frequency (IDF) technique.

7. The social media-based content recommendation apparatus of claim 1, wherein the information analysis unit determines whether a meaning of each of the one or more representative words is positive or negative, using a sentimental analysis technique.

8. The social media-based content recommendation apparatus of claim 1, wherein the information about the selected recommendable content comprises:
recommendable content item for displaying the selected recommendable content; and
a tag cloud for displaying social information about the recommendable content in a tag cloud form.

9. An interface device of a social media-based content recommendation apparatus for recommending content on the basis of information collected from social media, the interface device comprising:
a setting information display portion configured to display social media used by a user and provide a screen for setting a user information collection range of the displayed social media;
a recommendable content display portion configured to display one or more content items recommended by the content recommendation apparatus;
a tag cloud display portion configured to display information collected regarding to a content selected from among the recommended one or more content items, in a tag cloud form; and
a period setting portion configured to provide a screen for setting a search time of the displayed social media.

10. The interface device of claim 9, wherein the tag cloud display portion displays a positive word in a lighter color than a negative word, among the collected information.

11. The interface device of claim 9, wherein the tag cloud display portion displays a word having an appearance frequency more than a predetermined value, in a larger font than a word having an appearance frequency less than the predetermined value, among the collected information.

12. The interface device of claim 9, further comprising:
a first area for displaying the social profile setting screen and the search period setting screen; and
a second area for displaying the recommendable content and the tag cloud,
wherein the first area and the second area are switched back and forth so that only one of them is displayed.

13. A social media-based content recommendation method comprising:
receiving social media profile information including information about a social media of a user;
searching one or more social media sites for information about content on the basis of the received social media profile information;
analyzing retrieved information about the content; and
generating content recommendation information on the basis of the analyzed information about the content.

14. The social media-based content recommendation method of claim 13, wherein the social media profile information comprises search period information about the social media and user search range information about the social media.

15. The social media-based content recommendation method of claim 13, wherein the analyzing of the searched information about the content includes determining whether a meaning of a representative word is positive or negative, using a sentimental analysis technique.

16. The social media-based content recommendation method of claim 13, wherein the searching of the one or more social media sites for the information about the content on the basis of the received social media profile information includes selecting one or more of the one or more social media sites on the basis of the social media profile information, selecting a user search range of the selected social media, and selecting a search period of the selected social media.
